(19) United States
(12) Patent Application Publication
(10) Pub. No.: US 2005/0234646 A1
(43) Pub. Date: Oct. 20, 2005

(54) Tsunami hazard assessment system

(76) Inventor: Philip Watts, Long Beach, CA (US)

Correspondence Address: THE LAW OFFICE OF JOHN A. GRIECCI, 703 PIER AVE., SUITE B #657, HERMOSA BEACH, CA, 90254, US

(21) Appl. No.: 11/096,709

(22) Filed: Mar. 31, 2005

Related U.S. Application Data
(60) Provisional application No. 60/558,668, filed on Mar. 31, 2004.
(60) Provisional application No. 60/608,656, filed on Sep. 10, 2004.

(51) Int. Cl. G01W 1/00

(52) U.S. Cl. 702/3; 702/2

(57) ABSTRACT

A method of tsunami hazard assessment, including the steps of establishing a tsunami scenario, and compiling a plurality of geographic information layers regarding a particular tsunami hazard at a geographic location for a given target. Each layer pertains to target bodies characterized by a different characteristic set of one or more target characteristics. Each layer provides data representing the geographic area over which the hazard will occur to any present target bodies characterized by the characteristic set to which the layer pertains.

This application claims the benefit of U.S. Provisional Application No. 60/558,668, filed Mar. 31, 2004, and of U.S. Provisional Application No. 60/608,656, filed Sep. 10, 2004, each of which is incorporated herein by reference for all purposes.

The present invention relates generally to a hazard assessment system and, more particularly, to a tsunami hazard assessment system.

### BACKGROUND OF THE INVENTION

Large-scale earthquakes, landslides, volcanic eruptions, undersea slumps, and even meteor impacts can disturb bodies of water so as to form tsunamis, which are also known as a tidal waves. A tsunami can include one or more waves, which can radiate outward from the disturbance and cause significant loss of life and property when they make landfall. Furthermore, the waves can significantly hamper the operation of emergency services, in that they can destroy or obstruct access roads, and in that such services cannot operate in wave prone regions until it is established that the tsunami has passed.

Analysis of tsunamis is complicated by the variety of characteristics with which tsunamis can embody, and by the variety of effects they can have on landfall, based on a wide variety of factors, including local geography. Moreover, the various types of simulation data known in the art for analyzing tsunamis may not directly provide information useful for emergency planning or emergency operations.

Accordingly, there has existed a need for a need for a tsunami hazard assessment system for analysis and presentation of data for use in response to tsunami hazards. Preferred embodiments of the present invention satisfy these and other needs, and provide further related advantages.

### SUMMARY OF THE INVENTION

In various embodiments, the present invention solves some or all of the needs mentioned above, providing in preferred embodiments a tsunami hazard assessment system for analysis and presentation of data for use in response to tsunami hazards.

Embodiments of a method of tsunami hazard assessment, may feature the steps of establishing a tsunami scenario, and compiling a plurality of geographic information layers regarding a particular tsunami hazard at a geographic location for a given target. Advantageously, each layer may pertain to target bodies characterized by a different characteristic set of one or more target characteristics, and each layer may provide data representing the geographic area over which the hazard will occur to any present target bodies characterized by the characteristic set to which the layer pertains.

Other features and advantages of the invention will become apparent from the following detailed description of the preferred embodiments, taken with the accompanying drawings, which illustrate, by way of example, the principles of the invention. The detailed description of particular preferred embodiments, as set out below to enable one to build and use an embodiment of the invention, are not intended to limit the enumerated claims, but rather, they are intended to serve as particular examples of the claimed invention.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is an example of a geographic map of a first location, depicting where target people could remain standing during a tsunami, made under an embodiment of the invention.

FIG. 2 is an example of a geographic map of the first location, depicting where target cars could be moved during a tsunami, made under an embodiment of the invention.

FIG. 3 is an example of a geographic map of the first location, depicting where target buildings could fail during a tsunami, made under an embodiment of the invention.

FIG. 4 is an example of a geographic map of the first location, depicting where target boats could break free of their anchorage during a tsunami, made under an embodiment of the invention.

FIG. 5 is an example of a geographic map of the first location, depicting where target boulders could be displaced during a tsunami, made under an embodiment of the invention.

FIG. 6 is an example of a geographic map of the first location, depicting where target free-floating ships could be displaced during a tsunami, made under an embodiment of the invention.

FIG. 7 is an example of a geographic map of a second location, depicting contours of wave arrival time, made under an embodiment of the invention.

FIG. 8 is an example of a geographic map of the second location, depicting contours of wave maximum time, made under an embodiment of the invention.

FIG. 9 is an example of a geographic map of the second location, depicting contours of final wave time, made under an embodiment of the invention.

FIG. 10 is an example of a geographic map of the first location, depicting time of first wave arrival, made under an embodiment of the invention.

FIG. 11 is an example of a geographic map of the first location, depicting time of wave maximum, made under an embodiment of the invention.

FIG. 12 is an example of a geographic map of the first location, depicting time of final wave departure, made under an embodiment of the invention.

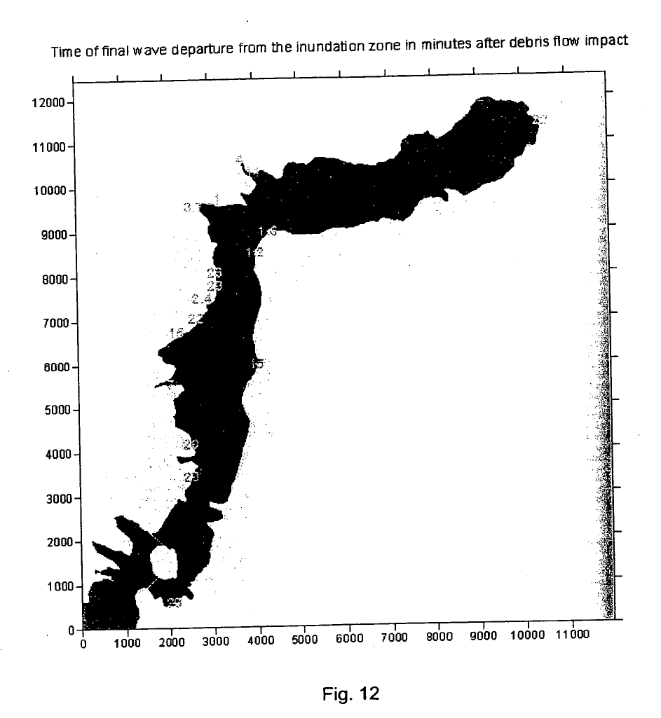

### DETAILED DESCRIPTION OF THE PREFERRED EMBODIMENTS

The invention may be understood by referring to the following detailed description, which should be read with the accompanying drawings. This detailed description of particular preferred embodiments of the invention, set out below to enable one to build and use particular implementations of the invention, is not intended to limit the invention, but rather, it is intended to provide particular examples of it.

Typical embodiments of the present invention reside in a hazard assessment system, such as for tsunami hazard assessment, that is, in methods of assessment, in methods of producing and/or using assessment maps, in methods of producing and/or using Geographic Information Systems tailored for assessment, and in maps or Information Systems (e.g., Geographic Information Systems) tailored for hazard assessment, such as for tsunamis, mass transport complexes, and the like. Hazard assessment is useful in numerous activities, such as hazard planning, hazard response, hazard mitigation and risk assessment.

A tsunami is associated with a large number of different hazards (i.e., possibilities that a given tsunami-related, and potentially dangerous, event will occur) that are based on the tsunami affecting various bodies (e.g., people, vehicles, rocks, buildings and boats). These affected bodies are potential targets of particular portions of the hazard assessment. The hazards include the possibility that people will be swept away, the possibility that vehicles will be displaced, the possibility that rocks will be displaced (such as on to a roadway), the possibility that buildings will be broken, and the possibility that boats will break free of anchors or moorings (and possibly be swept ashore). The possibility level of these hazards can vary significantly depending on characteristics of the target bodies (i.e., the affected body), such as the size, shape, weight and various material properties of the target bodies.

The hazard assessment system uses various types of fundamental simulation output data from one or more runs of a tsunami simulation model (e.g., a computerized simulation of a tsunami). These simulation output data may include maximum wave elevation, maximum water velocity and maximum water flux, along with other relevant information such as the timing of a first wave arrival at an inundation zone, the timing of a maximum water wave in the inundation zone, and the timing of a final wave departure from the inundation zone.

These simulation output data, the calculation of which are known in the art, are used as an input to a set of various, preferably simple, effect estimation routines to provide derived quantities that are directly useful for hazard assessment. The routines implement algorithms that estimate effects of a tsunami on target bodies, based on various assumptions. These assumptions preferably make the analysis as complex as necessary to achieve reasonable results, and as simple as possible to avoid the requirement of input data that is not known or does not significantly affect the results of the assessment. The assumptions, and the resulting algorithms, will typically be determined by an analyst skilled in the pertinent art.

The effect estimation routines typically comprise computer software in any of a variety of formats (e.g., subroutines, objects), but can also be implemented in computer hardware, physical calculation devices, or other methods of data calculation. Each routine is typically directed toward a particular hazard, such as the possibility that a person would be swept away. The routines calculate data for given scenarios, i.e., different particular events, such as a tsunami of a particular size that strikes a particular geographic area (coastal region). In addition to the above criteria that might be used in defining an event, other optional criteria of the scenario definition could include the particular direction from which the tsunami strikes, the local weather conditions (e.g., storm surge), the water conditions (e.g., tide), and the like.

For a given scenario and a given hazard, the routine calculates a finite plurality of characteristic-set layers. Each characteristic-set layer contains data representing the potential effects of the given scenario, over the scenario's geographic area (or a subset thereof), i.e., data representing the region over which a particular possibility level of the hazard exists, presuming the presence of targets. More particularly, each characteristic-set layer represents the geographic region over which the tsunami of the scenario inflicts a given result, which is a given probability (e.g., a high likelihood) that the possible hazard will occur (e.g., a person would be swept away) to present target bodies (e.g., a people) characterized by a particular characteristic set of one or more target characteristics (e.g., wherein the person was an average sized man, woman or child). The characteristic set can recite direct characteristics, such as the strength of a boat attachment line, or indirect characteristics, such as a current speed that would break an attachment line.

The assessment is preferably only run over relevant subsets of the total geographic area. This assessment area will typically be the area for which there is a significant possibility that the hazard can affect the target.

As will be seen in some of the figures described below, it can sometimes be the case that the regions of one layer significantly overlap the regions of other layers relating to the same target. This is more likely to happen for steep geographic terrains. For example, in a steep terrain, the regions for which all people are swept away might be very similar in size to the regions only women and children would be swept away. Nevertheless, even when this is the case, the small differences between regions might be particularly relevant. For example, in a relatively small location where only children would be swept away, a school presents a far more critical danger than a business district.

Because complex layering can sometimes unnecessarily complicate a hazard analysis, the number of different characteristic sets is preferably limited, i.e., small. This is particularly important for quick assessments during times of emergency management. The limited number of characteristic sets, which would typically create the same number of characteristic-set layers for a given target, might for example provide three characteristic-set layers representing average men, women and children for a target of people.

Nevertheless, the number of characteristic sets (and related layers) may be determined on a case by case basis by considering the relevant levels of effect (e.g., the important differences in danger level or damage level). For example, when considering the usability of critical roadways on which rocks have been deposited by a tsunami, the relevant effect levels might pertain to ranges of rock sizes over which various vehicles can, and cannot pass. In such a case, the number of character sets might be determined by considering the maximum boulder sizes over which different types of regular and emergency vehicles could pass.

Example Hazards

Example Target: People

Following the above discussion, a first example of a tsunami hazard assessment, under the present invention, pertains to the hazard that a person could be unable to stand at a particular location throughout the inundation of that location by a particular hypothetical tsunami. The invention entails the use of routines to calculate data for three characteristic sets that define three levels of hazard assessment, and thus produce three characteristic-set layers of data. The three characteristic sets are based on characteristics pertaining to the size of an average man (a large size), an average woman (a medium size), and an average child (a small size), respectively.

The appropriate assessment area will generally be any potentially inundated land area where people might be standing. Prior to the tsunami arrival, water might drain away from the beaches, and people might walk out onto the drained seabed. Therefore, the assessment area includes inundated land areas and temporarily exposed seabed areas.

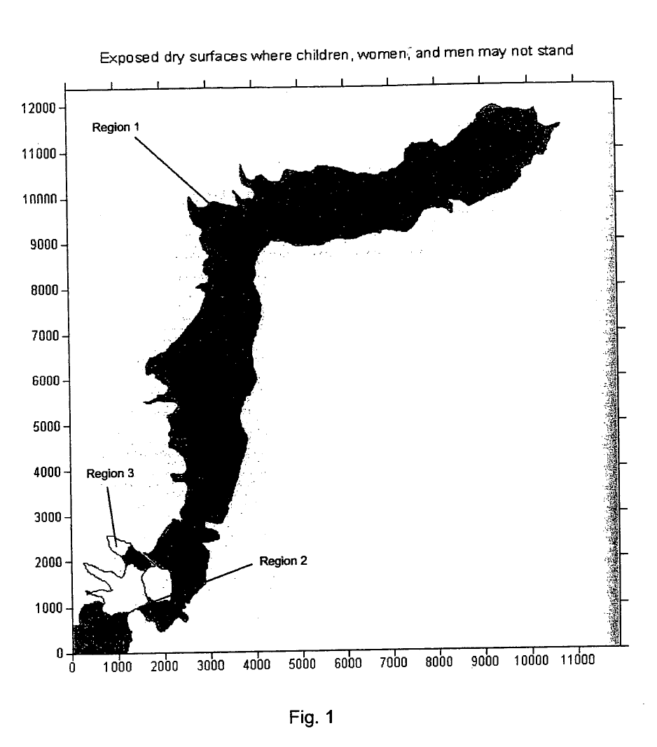

The resultant data can be plotted on a geographic map, with different map colors used to define the following regions: 1) regions where nobody could remain standing; 2) regions where only the men could remain standing; 3) regions where the men or women, but not the children, could remain standing; and 4) regions where men, women and children could all remain standing (see, e.g., FIG. 1). Alternatively (or additionally), the resultant data can be plotted on a plurality of (e.g., three) geographic maps that each depict one characteristic-set layer of information. For example, each map could depict a different region of the following regions: regions where men could not remain standing, regions where women could not remain standing, and regions children could not remain standing. Also, the last of these maps typically would define the regions where men, women and children could all remain standing.

Example Target: Vehicles

A second example of a tsunami hazard assessment, under the present invention, pertains to the hazard that a vehicle at a particular location would be displaced (i.e., moved) during the inundation of that location by a particular hypothetical tsunami. The invention entails the use of routines to calculate data for three characteristic sets that define three levels of hazard assessment, and thus produce three characteristic-set layers of data. The three characteristic sets are based on characteristics pertaining to the size of a sport utility vehicle (“SUV”) (i.e., a large size), a large sedan (a medium size), and an economy car (a small size), respectively. Additional characteristic sets might be added for other vehicles, such as trucks of various sizes. The appropriate assessment area will generally be any potentially inundated land area where vehicles might be found.

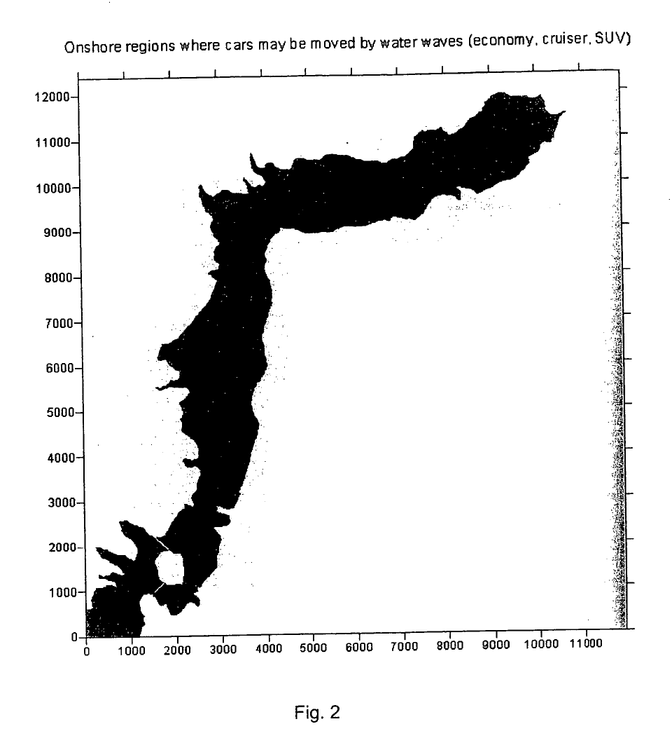

The resultant data can be plotted on a geographic map, with different map colors used to define the following regions: 1) regions where all analyzed vehicles would be displaced; 2) regions where only the SUVs would not be displaced; 3) regions where neither the SUVs nor the large sedans would be displaced; 4) and regions where none of the vehicles would be displaced (see, e.g., FIG. 2). Alternatively (or additionally), the resultant data could can be plotted on a plurality of (e.g., three) geographic maps that each depict one characteristic-set layer of information. For example, each map could depict a different region of the following regions: regions where SUVs would be displaced, regions where large sedans would be displaced, and regions where economy cars would be displaced. Also, the last of these maps typically would define the regions where none of the vehicles would be displaced.

Example Target: Buildings

A third example of a tsunami hazard assessment, under the present invention, pertains to the hazard that man made structures such as buildings, at a particular location during the inundation of that location by a particular hypothetical tsunami, will have structural failure. The invention entails the use of routines to calculate data for three characteristic sets that define three levels of hazard assessment, and thus produce three characteristic-set layers of data. The three characteristic sets are based on characteristics pertaining to the strength of brick portions of a structure, the strength of wood portions of a structure, and the strength of a glass structure, respectively. The appropriate assessment area will generally be any potentially inundated land area where buildings might be found.

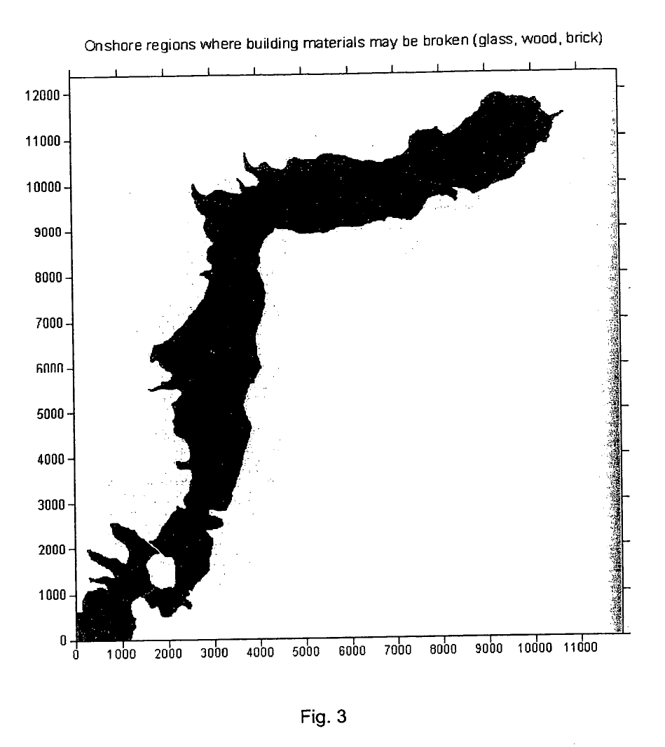

The resultant data can be plotted on a geographic map, with different map colors used to define the following regions: 1) regions where all structures would fail; 2) regions where typical glass and wood structures would fail; 3) regions where only glass structures would fail; and 4) regions where none of the analyzed target bodies would fail (see, e.g., FIG. 3). Alternatively (or additionally), the resultant data could can be plotted on a plurality of (e.g., three) geographic maps that each depict one characteristic-set layer of information. For example, each map could depict a different region of the following regions: regions where brick structures would fail, regions where wood structures would fail, and regions where glass structures would fail. Also, the last of these maps typically would define the regions where no structures would fail.

Example Target: Boats

A fourth example of a tsunami hazard assessment, under the present invention, pertains to the hazard that the attachment lines of boats held by anchors or moorings would break, freeing the boat to drift, and potentially to be washed aground. The invention entails the use of routines to calculate data for three characteristic sets that define three levels of hazard assessment, and thus produce three characteristic-set layers of data. The three characteristic sets are based on characteristics pertaining to the strength of the attachment line (i.e., the chain or rope connecting the boat to the anchor or mooring). This can be specified directly, with force levels defining the various strength limits, or indirectly, such as by using industry-specific methods of describing line strength. In this example, the characteristic line strength is recited in knots, which is well known in shipping. This standard thus reflects both the strength of the attachment line and the weight of the boat. In particular, the three characteristic sets are based on characteristics pertaining to 1 knot lines, 2 knot lines, and 3 knot lines, respectively. The appropriate assessment area will generally be any relevant part of the body of water where boats might be exposed to the tsunami.

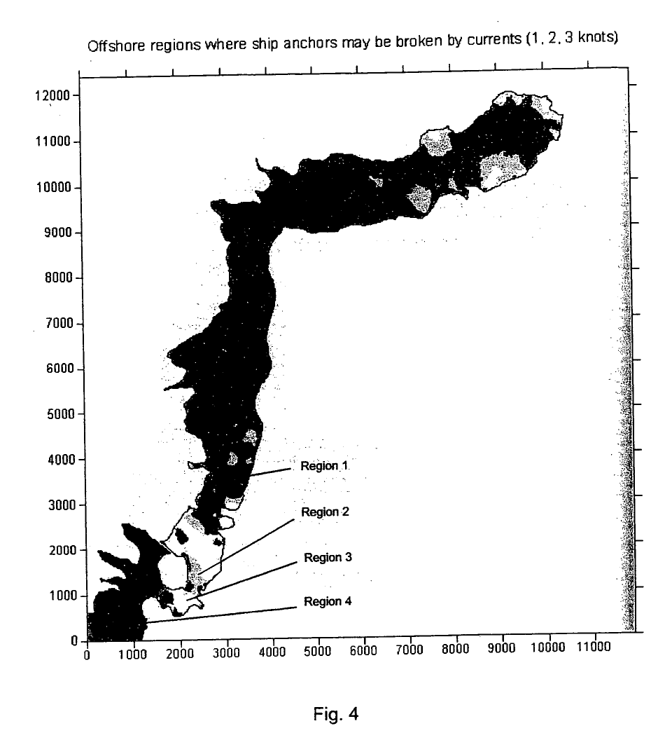

The resultant data can be plotted on a geographic map, with different map colors used to define the following regions: 1) regions where boats having up to and including 3 knot lines would break free; 2) regions where boats having up to and including 2 knot lines would break free; 3) regions where boats having up to and including 1 knot lines would break free; and 4) regions where none of the analyzed boats would break free (see, e.g., FIG. 4). Alternatively (or additionally), the resultant data could can be plotted on a plurality of (e.g., three) geographic maps that each depict one characteristic-set layer of information. For example, each map could depict a different region of the following regions: regions where boats having 3 knot lines break free, regions where boats having 2 knot lines break free, and regions where boats having 1 knot lines break free. Also, the last of these maps typically would define the regions where no analyzed boats would break free.

Example Target: Rocks

A fifth example of a tsunami hazard assessment, under the present invention, pertains to the hazard that rocks (i.e., gravel and/or boulders) could be moved, and therefore potentially deposited at a particular location during the inundation of that location by a particular hypothetical tsunami. This hazard is of particular importance in assessing whether roads and parking lots will be accessible to emergency vehicles after the tsunami has receded. The invention entails the use of routines to calculate data for three characteristic sets that define three levels of hazard assessment, and thus produce three characteristic-set layers of data. The three characteristic sets are based on characteristics pertaining to the size of a 2 meter rock (i.e., a large, breakwater-boulder-sized rock), a 0.2 meter rock (a medium rock), and a 0.02 meter rock (a small rock), respectively. The appropriate assessment area will generally be any relevant part of the inundated land area or the body of water where rocks could be moved under the tsunami scenario.

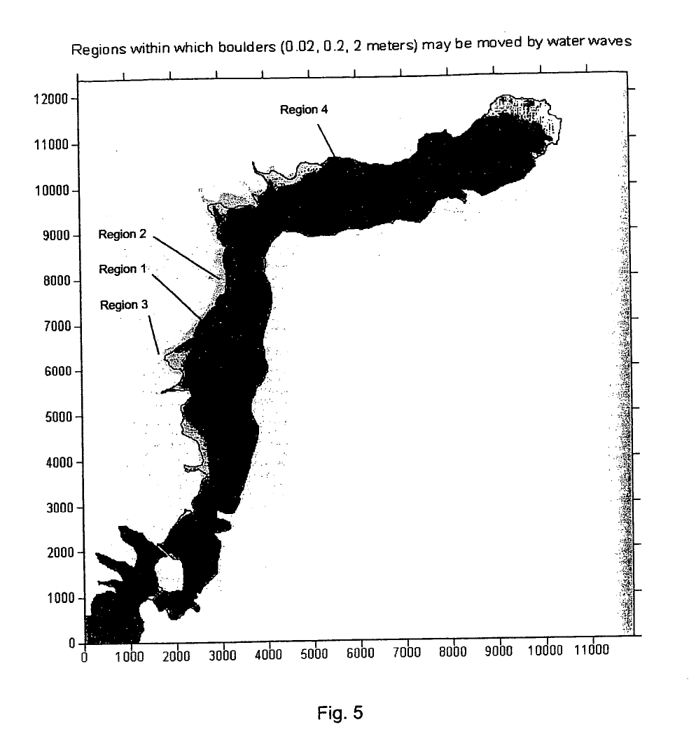

The resultant data can be plotted on a geographic map, with different map colors used to define the following regions: 1) regions where rocks of all sizes would be moved; 2) regions where small and medium rocks would be moved; 3) regions where only small rocks would be moved; and 4) regions where no rocks at or above the 0.02 meter range would be deposited (see, e.g., FIG. 5). Alternatively (or additionally), the resultant data could can be plotted on a plurality of (e.g., three) geographic maps that each depict one characteristic-set layer of information. For example, each map could depict a different region of the following regions: regions where 2 meter rocks would be deposited, regions where 0.2 meter rocks would be deposited, and regions where 0.02 meter rocks would be deposited. Also, the last of these maps typically would define the regions where no rocks characterized as 0.02 meters and above deposited.

Additional Notes on Characteristic-Set Layers

In typical analyses, such as those described above, the resultant characteristic-set layers are subsets of one another. In such cases, the results are typically depicted as a first region where target bodies having all characteristic sets are affected, one or more regions where one, and/or two or more regions representing all target bodies being affected except for those falling within one, and/or two or more respective characteristic sets, and a final region where no target bodies are affected. Each region is a subset within all regions where more characteristic sets are affected. In such a case the results are conveniently described on a single map by overlaying each region to show the differences between them.

Another hypothetical variation of assessments such as those described above, for a particular hazard, would pertain to characteristic sets that do not form subsets of one another. For such combinations of hazards, targets and characteristic sets, either more complicated color coding would be necessary (i.e., having colors representing particular combinations of characteristic sets), or the results would more conveniently be described on separate maps representing each characteristic-set layer of hazard.

Other Hazards, Targets and Characteristics

A variety of other hazards could be assessed. For example, instead of or in addition to the hazard of vehicle displacement (as described above), layers could be developed for the hazard of submerged vehicles. As with the prior assessment, the vehicles are the targets, and the characteristic sets could include SUVs, large sedans and economy cars. The difference is in the particular hazard.

Likewise, a variety of other targets could be analyzed. For example, similar to those of rock targets, maps could be developed for sediment deposition, with characteristic sets (and layers) relating to sediment size or to geographic locations of thin deposits, and geographic locations of thick deposits. The selection of targets for an assessment would typically relate to common tsunami hazard factors present (e.g., the presence of people, the presence of structures, reliance on costal roads or utilities, and the like) in a particular region.

Also, a variety of other characteristics relating to different possible levels of hazard could be utilized for a given hazard and target. For example, for a target of vehicles and a hazard of vehicle displacement, the vehicle orientation (i.e., the way the vehicle is facing) could be a characteristic of the characteristic sets. Under such characteristic sets, the resulting layers would differentiate between what would happen to vehicles parked or traveling parallel to a wave front, and what would happen to vehicles parked or traveling normal to a wave front.

Further Layers of Information

A variety of other types of information layers are preferably used with the characteristic-set layers. For example, additional layers preferably provide local geographic information, and further layers provide data on the typical presence of target bodies, or even real-time data on the actual presence of target bodies. For example, at various geographic locations, layers may be used to provide the number and characteristics of people who are present, the types of vehicles, the locations of roads, the types of structures, and the locations of critical structures (such as police stations, fire stations, hospitals and schools).

It should be noted that the characteristic-set layers described above do not presume the presence of target bodies, and are therefore not simulating actual occurrences of the possible hazard. Likewise, the characteristic-set layers described above do not predict particulars of the hazard occurrence (e.g., they do not predict the direction that boulders or boats will be carried). Instead, the layers identify regions where the results would occur if the target bodies are available. Actual information on target body availability is preferably provided in separate layers of information that could be depicted in separate maps, as noted above.

Another type of information layer preferably provides geographically defined regions of like tsunami characteristic magnitudes (for a given scenario). More particularly, each layer pertains to a range of tsunami characteristic magnitudes (e.g., motions on the order of a certain magnitude) characterized by a different characteristic set of one or more tsunami characteristics (e.g., side-to-side motion). For example, in a given scenario, water movement might cause free floating boats to move in alternating directions by various distances, depending on the location of the boat. Therefore, water-movement/boat-movement layers could present the magnitudes of such movement as a form of tsunami-characteristic-magnitude layers. The appropriate assessment area will generally be any relevant part of the body of water, and possibly any relevant part of the inundated land area.

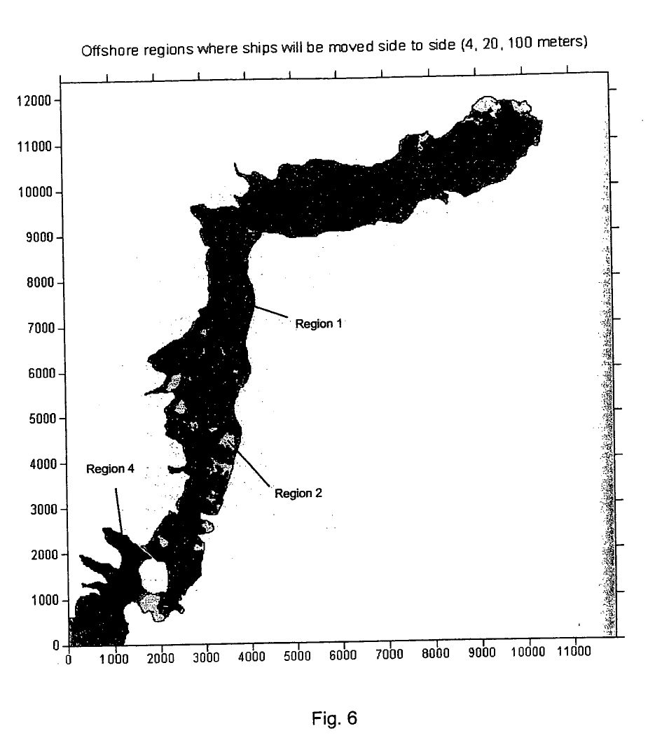

A first such boat-movement layer might represent geographic regions where boats move 100 meters in alternating directions (e.g., from side to side). Second and third related layers might represent 20 meter and 4 meter movements, respectively. The resultant data can be plotted on a geographic map, with different map colors used to define the following regions: 1) regions where boats move at least 100 meters in alternating directions; 2) regions where boats move at least 20 meters in alternating directions; 3) regions where boats move at least 4 meters in alternating directions; and 4) regions where boats do not move at least 4 meters in alternating directions; (see, e.g., FIG. 6). These layers, in combination with the geography of the shoreline could establish the locations of safe zones where free floating boats will not generally be washed ashore. Furthermore, when combined with characteristic-set layers relating to the breaking of boat anchor lines, these boat-movement layers could establish minimum line strength needs for particularly dangerous anchorage and mooring locations.

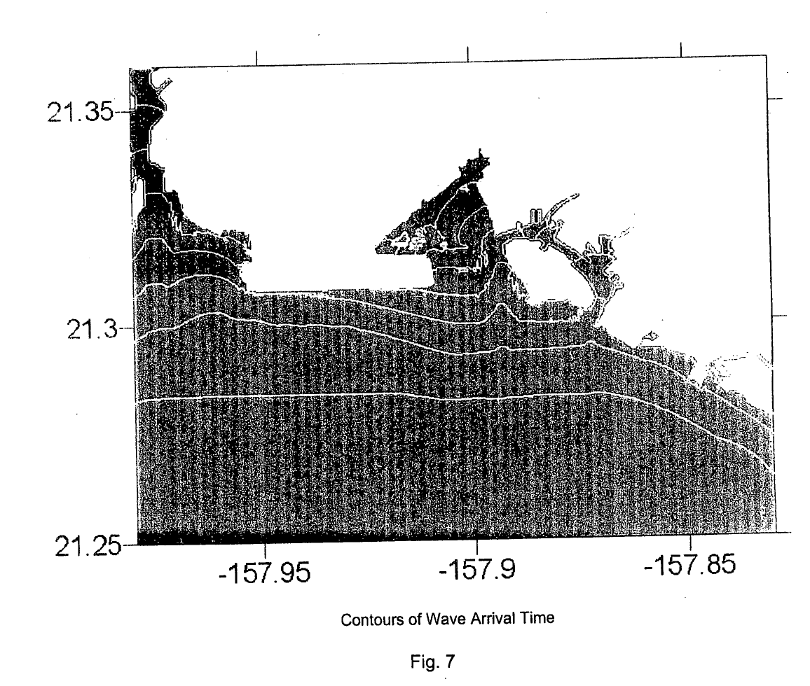

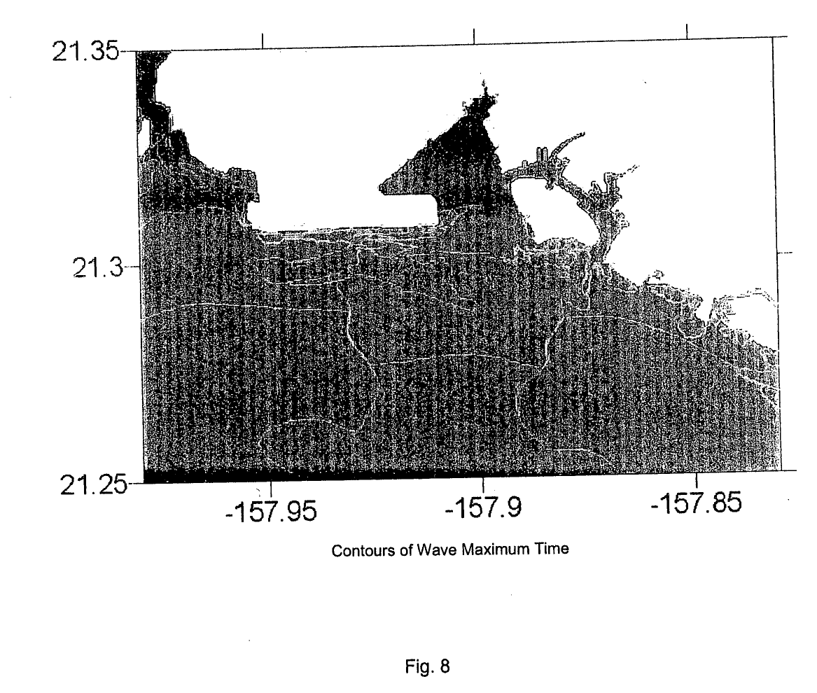

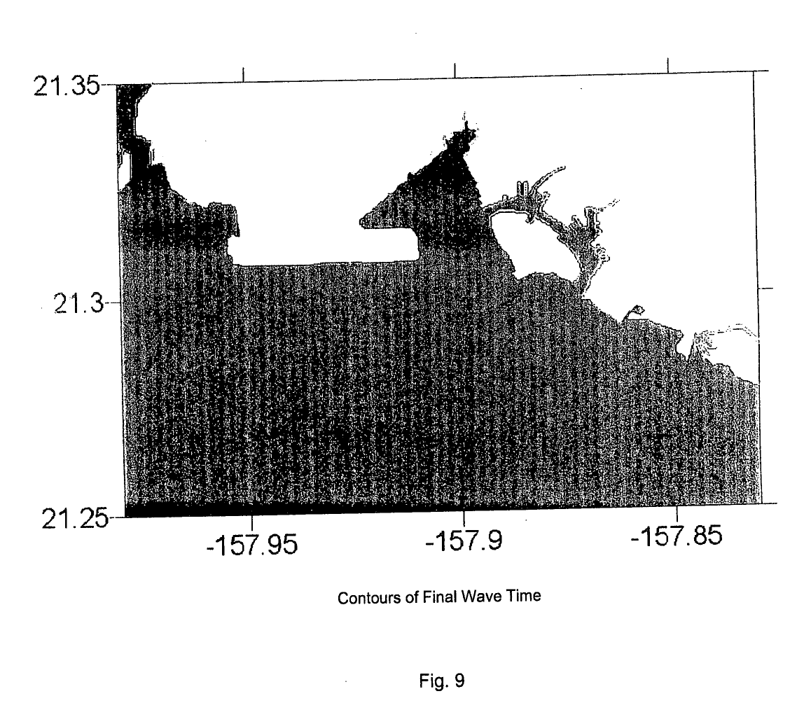

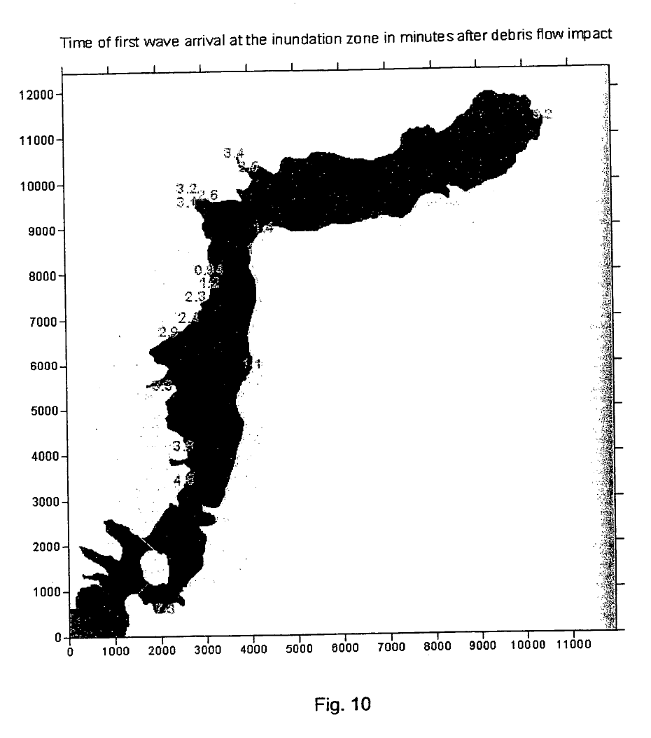

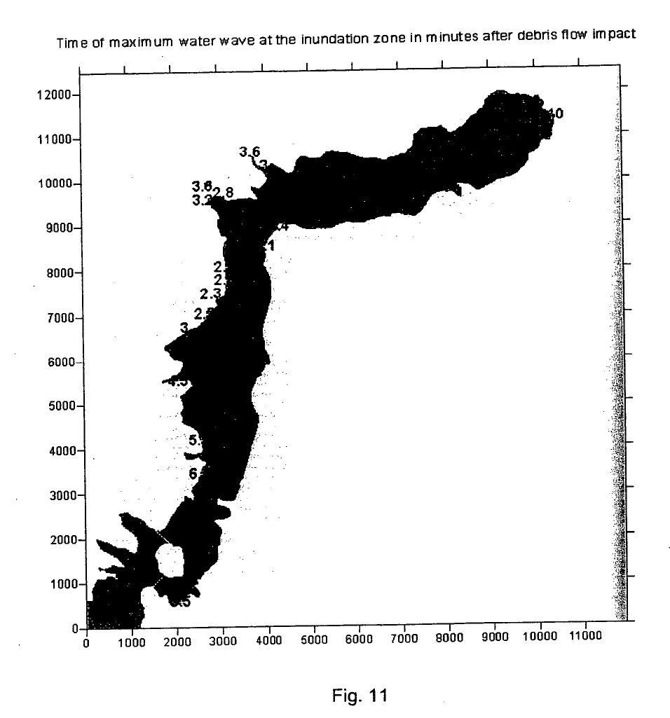

Yet other types of information layers that are preferably used pertain to data that represent wave timing. These layers could be contours of wave arrival time (see, e.g., FIG. 7), contours of wave maximum time (see, e.g., FIG. 8), contours of final wave time (see, e.g., FIG. 9), times of wave first arrival at the inundation zone with respect to a reference time (such as the time that a wave was formed) (see, e.g., FIG. 10), times of maximum water wave at the inundation zone with respect to a reference time (see, e.g., FIG. 11) and/or times of final wave departure from the inundation zone with respect to a reference time (see, e.g., FIG. 11). These data, among other things, can be used with the vehicle-orientation characteristic-set layers described above to assess the likely hood of vehicle displacement of vehicles on roads, in parking lots, and in other locations where the orientation of the vehicles are generally known.

Maps

As frequently noted above, the various layers, including the characteristic-set layers, can be represented in various types of inundation maps. Such maps can be used by analysts to conduct tsunami hazard assessments that account for the availability of various target bodies and the particularities of various scenarios. The assessment techniques would be similar to prior techniques, but the additional information contained in the above-described layers potentially may provide for more detailed, useful and expeditious assessments.

More particularly, relevant combinations of the layered information in the maps provides an assessment tool for comparing relevant layer data and producing tsunami hazard assessment results, such as geographically based estimates of the total cost of the damage, the numbers of lives in danger (or potentially lost), the types of losses that might be incurred, and the like. Using various tsunami hazard assessment results, emergency response plans may be prepared in advance for a variety of scenarios. Under such plans, there can be community training efforts, emergency notification plans (such as automated phone calls to notify the police and fire departments, coastal hospitals and public utilities, and costal hotels and residents. Likewise, under such plans, emergency crews can plan the timing and order of their efforts, and take into consideration road blockages, ongoing water dangers to rescue efforts, and the locations of highest victim need.

Therefore, the preparation and production of the above-identified inundation maps relating characteristic-set layers and/or tsunami-characteristic-magnitude layers, the production of useful sets including relevant combinations (as noted above) of these layers, and the use of such sets of maps for hazard assessment (including hazard planning, hazard response and hazard mitigation), are within the anticipated scope of the invention.

GIS

Preferably, the data forming the various layers described above are compiled in respective layers of a geographical information system (“GIS”). As with the maps described above, the GIS provides an assessment tool for comparing relevant layer data and producing tsunami hazard assessment results. Using various tsunami hazard assessment results, emergency response plans may be prepared, and emergency crews can plan the timing and order of their efforts.

Therefore, the programming of layers representing the above-identified inundation map layers relating to characteristic-set layers and/or tsunami-characteristic-magnitude layers, the method of production of computer systems programmed with a GIS incorporating such layers, and the use of such a computer system for tsunami hazard assessment (including hazard planning, hazard response and hazard mitigation), are within the anticipated scope of the invention.

Routines

In developing the characteristic-set layers and/or tsunami-characteristic-magnitude layers described above, various combinations of the above-noted routines are particularly useful. Additionally, routines for automatically importing such layers into a GIS are particularly useful. The preparation and production of the above-identified routines for characteristic-set layers and/or tsunami-characteristic-magnitude layers, the production of useful sets of such routines, and the use of such routines for the development of hazard assessment layers are within the anticipated scope of the invention. Furthermore, the routines themselves are within the scope of the invention, as available on a computer readable medium. Likewise, a computer configured to run such routines is within the scope of the invention, as is transmissions from a computer that incorporate the routines or the results of running the routines.

Calculation of Layers

With regard to the above-recited figures, examples of data calculation relating to some of the above-described levels is provided in the following exerts from a study of Baker Lake. These exerts have been modified to fit in the context of the present document. These examples consider the lake subject to impulse-generated waves from a debris flow that enters the lake.

The examples uses the public-domain Boussinesq model FUNWAVE developed by J. T. Kirby and coworkers at the University of Delaware. FUNWAVE handles frequency dispersion in a manner that simulates deep-water waves, models the fluid mechanics of breaking waves, and simulates inundation.

Assessment Using Layers

A useful assessment method under the invention is to prepare assessment maps that include composites of layered information that are relevant to a particular danger, where a danger typically relates to the outcome of a hazard occurring to a target body. For example, for the danger of a critical road being obstructed by rocks after a tsunami recedes, the relevant layers would include rock-movement hazard layers for rocks of adequate size to obstruct vehicles on the critical roads, layers identifying the locations of such adequate sized rocks, and layers either identifying the location of roads, or more preferably, identifying the location of critical roads. Preferably, these assessment maps do not contain layers that are not relevant to a particular danger. As a result, a trained analyst could look at a printout of such a critical road assessment map and immediately identify the locations of critical roads that could likely be obstructed. Preferably a GIS is programmed to produce such maps upon identification of the relevant assessment map layers.

A further useful assessment method under the invention is to develop the above-described assessment maps, and then remove (preferably using a computer algorithm) all data not indicating the actual presence of a danger. For example, a computer programmed with appropriate routines could take a critical-road location layer, and overlay it with only the portions of a rock-movement hazard layer that: 1) is indicated (by the rock location layer) to overlap rocks of adequate size to obstruct; and 2) overlaps a critical road identified in the critical-road location layer. Thus, this map will show critical roads, and only the rocks and rock-movement hazard areas that could obstruct one or more critical roads. Using this map, even an inexperienced person could likely identify where possible dangers (e.g., closed roads) will likely occur.

Groups of either of the above assessment maps could be developed for some or all typical tsunami dangers for which geographic regions are typically subjected. Developing, displaying, printing, summarizing, and using such maps, and groups of maps, to rapidly assess an array of one or more dangers are all within the scope of the invention. Notably, this aspect of the invention could optionally include within its scope the development of assessment maps that do not include characteristic-set layers as described above.

Baker Lake Example

Tsunami Inundation Maps for Emergency Response

Although typical tsunami inundation maps (see, e.g., U.S. National Tsunami Hazard Mitigation Program Review and International Tsunami Symposium Seattle, Wash., 7-10, August 2001, http://www.pmel.noaa.gov/its2001) could be represented as layers in a GIS format, they may not necessarily provide information in the best form for emergency planners. Tsunami amplitude and run-up are straightforward enough concepts for a non-specialist audience, but water velocity and water flux are not, and wave-gauge simulations may be confusing. We expect that emergency planners are more likely to be interested in predictions regarding wave timing and probable effects on people and property. To this end, we present additional results regarding tsunami inundation, understood in the broader sense of tsunami impact. We employ simple engineering models to illustrate the consequences of tsunami attack in a way that emergency managers can readily understand and use. Results are presented in the form of inundation maps based on derived quantities, each separated into three distinct “layers” (in a GIS sense) to represent increasing degree of hazard. Given the uncertainty involved in numerical simulations, as well as the many local variables that can alter the outcome during a real event, our inundation maps are meant to provide general guidelines as to the possible consequences of tsunami attack. Some complementary GIS methods for assessing tsunami-related risk are presented by Papathoma et al. (2003).

Wave Timing

In general, areas at risk of inundation must be evacuated before the first water wave arrives (at time tₐ), and emergency crews will probably not enter a devastated region until the last water wave has departed (at time t_{f}). The greatest water-wave hazard exists at some intermediate time tᵢ, plausibly chosen as the time of maximum tsunami amplitude. However, t_{f} is pertinent because the number of hazardous waves that will strike a given coastline is difficult to predict, and tsunami fatalities have resulted from the mistaken belief that water wave activity had ceased (e.g., Atwater et al. 1999).

At Baker Lake, waves would reach every point along the shoreline within several minutes of debris-flow impact. Comparable values of tₐ can be expected for other lakes of similar extent and depth. Details of wave timing generally reflect peculiarities of lake bathymetry, such as the shallowness of the northeastern arm of Baker Lake. Near the impact region, tᵢ≈tₐ, but farther away from the impact region, tᵢ exceeds tₐ by as much as several minutes, and tᵢ is commonly associated with the arrival of edge waves. Because the maximum hazard lags the start of inundation by several minutes, rapid evacuation may save lives. In addition, because the time of final wetting lags the start of inundation by twenty minutes or more, emergency personnel should exercise caution in entering the inundation zone.

Effect on Boats

Tsunamis often have their greatest impact on harbors and ports, and a common image of the aftermath of tsunami attack is a boat marooned on dry land. If a boat is anchored, displacement might be thought to be limited to the anchor slack, but this is only true if an anchor does not break due to forces associated with the water waves. A similar situation arises with moored boats.

As a first approximation, water velocity (not wave velocity) may be considered the most basic measure of potential boat displacement. Consider (for the Case II scenario) the maximum water velocity, Uₘₐₓ, approximately halfway down the water column. This is an appropriate location to consider the impact of water velocity on anchors. Anchors are conventionally rated by their “holding power” Fₕ, meaning the maximum force required to dislodge the anchor (Hunley and Lemley 1980). An approximate criterion for anchor “failure” during a tsunami is that the drag force F_{d} on the anchor line exceeds Fₕ. We estimate F_{d}≈ρ_{w}Uₘₐₓ²hDₐ, where ρ_{w} is the density of water and Dₐ is the diameter of the anchor line, and thus the criterion for anchor failure is Uₘₐₓ≈\sqrt{Fₕ/ρ_{w}hDₐ}. In practice, Fₕ and Dₐ vary from ship to ship, so no universal failure criterion can be written. However, to illustrate the method, we choose Fₕ=300 kg, Dₐ=15 mm (reasonable values for recreational watercraft) and ρ_{w}=1000 kg/m³, so that Uₘₐₓ≈\sqrt{20/h} for Uₘₐₓ in m/s and h in m. As the shallowest part of Baker Lake has h≈20 m, we estimate that any anchored ship on Baker Lake would come adrift for Uₘₐₓ≧1 m/s (1.9 knots). We therefore separate the maximum water velocity Uₘₐₓ into three hazard layers: greater than 0.5 m/s, greater than 1.0 m/s, and greater than 1.5 m/s. In this case, a resulting figure (see, e.g., FIG. 4) demonstrate that the criterion Uₘₐₓ≧1 m/s is satisfied over most of Baker Lake, so we conclude that practically any boat on the lake—whether free floating, anchored or moored—will be set adrift by tsunami action.

Calculated side-to-side motions provide a basis for judging whether a free-floating ship is likely to strike some object or run aground. The magnitude D of lateral displacement was estimated using the relation D≈2Uₘₐₓ|tₘₐₓ−tₘᵢₙ|/3, where Uₘₐₓ is the maximum water velocity of a parcel of water approximately halfway along the water column connecting the boat to the lakebed, tₘₐₓ is the time of the maximum-elevation wave, and tₘᵢₙ is the time of the minimum-depression wave. A parabolic velocity profile in time was assumed and the approximate ⅔ factor was found by integration. This expression for D is reasonable because the maximum-elevation and minimum-depression waves almost always occur back to back in time. Moreover, this approach seems preferable to estimating D from actual (Lagrangian) water-parcel trajectories, which may in general be rather chaotic. It turns out that D≧100 m for about 99% of Baker Lake.

Sediment Transport

Geologic interpretation of possible tsunami deposits from historical events is a contentious topic. A deposit can be formed if there is an appropriate sediment source, but formation does not guarantee preservation in the geologic record (for example, Dawson and Shi 2000). Without entering into this controversy, we have developed an approximate method for estimating the likelihood of deposit formation in the event that a source of fine-grained sand is available. We consider fine-grained sand because it is likely to be common in many near-shore environments and is certainly common in tsunami deposits (Dawson and Shi 2000). To be specific, we consider a grain size d≈0.19 mm, in the middle of the fine-sand range. Our method further relies upon sediment-transport relations developed for quasi-steady flows. Steady-state sediment-transport relations should be roughly applicable, because the characteristic wave period in a tsunami is several minutes—much longer than the period of wind-induced waves. Moreover, the tractive stresses associated with tsunamis should generally be much stronger than those associated with wind-induced waves. We emphasize that we do not explicitly simulate sediment transport, nor do we calculate either the flux or the precise trajectory of mobilized sand. Rather, our approach is to identify regions where fine sand may become mobilized if such material is available. In a GIS context, for example, one could overlay a map of regions of potential sand mobilization with a map of actual sediment sources to decide if sediment transport can actually be expected.

The tsunami initially mobilizes sand as bedload. We use as the criterion for the onset of bedload transport θ>θ_{c}, where θ≡u_{*}²/(γ−1)gd is the Shields' stress, γ is the specific gravity of the sand, and θ_{c} is an empirical threshold value. We take θ_{c}≈0.06, corresponding to γ=2.67 and a water temperature of 10° C. (e.g., Julien 1998, p. 116). Bedload transport therefore occurs for u_{*}≧0.014 m/s. We then relate the friction velocity u_{*} to Uₘₐₓ by assuming a typical logarithmic “law of the wall” velocity distribution (Julien 1998, p. 98-99). Because water depth varies, we adopt the approximation u_{*}≈0.03 Uₘₐₓ (acknowledging that the error in our calculation may be substantial—say 50%) and find that the threshold for bedload transport is Uₘₐₓ≈0.47 m/s.

The two other layers in our inundation map are based on suspended load transport by tsunami activity. Suspended load is essentially maintained by turbulent mixing strong enough to loft sedimenting sand particles. The relative importance of suspended load as compared to bedload depends on two ratios: u_{*}/vₛ, where vₛ is particle settling speed, and h/d (Julien 1998, p. 187). For the grain size considered here, we find vₛ≈20 mm/s. As long as h≧1000 d—which here means h≧0.19 m—suspended-sediment flux qₛ equals bedload flux q_{b} for u_{*}/vₛ≈1.8 (equivalent to Uₘₐₓ≈1.2 m/s) and qₛ/q_{b}>10 for u_{*}/vₛ≧3.0 (equivalent to Uₘₐₓ≈2.0 n/s). Unlike bed load transport, there will only be significant suspended load transport with finite water depth. We choose an arbitrary water depth h=μm in order to find water flux criteria f_{w}≈1.2 m²/s and f_{w}≈2.0 m²/s along with the velocity criteria given above, respectively. When the velocity and flux criteria are satisfied simultaneously, then there is a possibility of significant suspended load transport. The combined velocity and flux criteria form the second and third layers of our inundation map.

We add one last feature to the third layer of this inundation map: significant suspended load is assumed to exist wherever wave breaking occurs, regardless of the velocity or flux. Wave breaking can be assumed to yield a strong localized mixing of bottom sediment within the water column. We therefore indicate the extent of wave breaking, which is likely to cause significant entrainment of suspended sediment. Kennedy et al. (2000) describe the modeling of wave breaking within FUNWAVE.

We construct a single tsunami inundation map for sediment transport using the three layers described above. These three layers are depicted for the case II Baker Lake tsunami in a figure (see, e.g., FIG. 5), which provides a rough indication of the areas on dry land where tsunami deposits may be found. Because the physical processes involved in sediment transport and deposition are complex and stochastic in nature, such a figure can only provide general guidance and should be used accordingly.

Finally, we separately consider the incipient movement of gravel and boulders separately from bedload transport, as relatively large clasts are likely to be irregularly found near shore rather than forming a continuous source layer anywhere. We suppose that a large clast resting on a sandy substrate will be displaced whenever the hydrodynamic drag force exceeds friction between the boulder and the bed (cf. Noji et al. 1993; Nott 1997). This criterion may be stated as

$${U}_{max} \geq \sqrt{( \frac{2 μ g b}{{C}_{d}} ) [ γ ( \frac{b}{h} ) - 1 ]} \qquad ( 4 )$$

where the hydrodynamic drag coefficient is denoted by C_{d}, the coefficient of friction is μ, and we have considered a cubic clast with a side of length b. The ratio b/h should be set equal to 1 wherever h>b. We use C_{d}=1 as a conservative estimate, and we take μ≈0.3 for large clasts resting on sand and γ=2.67 as before. A large clast may begin to roll after being set into motion, especially if sand is plowed up in front of the clast. However, a simple balance of moments about one edge of the clast shows that the water velocity needed to initiate rolling from rest is about three time larger than the value satisfying Equation (4). We consider three clast sizes (20 mm, 200 mm, and 2 m) to create the layers in the tsunami inundation map. Again, a figure is used to show where gravel and boulders are likely to be moved for the case II flow into Baker Lake, in regions exposed by the minimum depression wave and covered by the maximum elevation wave in the tsunami inundation map (see, e.g., FIG. 5).

Comparing these figures to pertinent USGS topographic maps, one can conclude whether sediment and boulders, if available, are likely to be deposited on roads and parking lots adjacent to campgrounds and boat ramps on the shores of Baker Lake.

Forces on Structures

Where tsunami-prone land contains man-made structures, it is useful to have a general measure of the likelihood of structural failure—a measure that describes wave forcing without requiring specific knowledge of either the structure or the direction of tsunami attack. To do this, we estimate a fluid-dynamical force that is readily converted into an estimate of a force applied to a structure. In particular, we write

$${F}_{w} \approx \frac{{ρ}_{w} {U}_{max}^{2} h}{2} \qquad ( 5 )$$

as a measure of the applied force F_{w} per unit width along shore. As long as h is less than or equal to the structure height, the value of F_{w} calculated from Equation (5) need only be multiplied by the structure width to get a representative force. We separate F_{w} into three hazard layers: greater than 10 N/m, greater than 100 N/m, and greater than 1000 N/m. A figure can then show where F_{w} exceeds various threshold values for the case II scenario. Almost every inundated region around Baker Lake is subject to F_{w}≧1000 N/m. The actual vulnerability of any particular structure clearly depends on diverse factors. We have not specifically calculated wave forces exerted on Upper Baker Dam, but model outputs could be used for this purpose.

People and Vehicles

We consider the trade-off between “bed” friction and hydrodynamic drag to assess people's ability to stand within the inundation zone, as well as the potential movement of cars due to tsunami action. People who lose their footing during inundation are commonly swept away and drowned, and cars are commonly displaced by tsunamis, sometimes with occupants inside (Atwater et al. 1999). Calculations presented here provide at best approximate guidelines owing to diverse, unpredictable factors that can influence the outcome.

We suppose that a person in ankle-deep water will be swept off his or her feet when the speed of the water is some critical value Uₐ, say, calculated from a balance of frictional and hydrodynamic forces:

$${U}_{a} \approx \sqrt{\frac{μ m g}{{ρ}_{w} {C}_{d} {D}_{l} {D}_{a}}} \qquad ( 6 )$$

where m is the person's mass, Dₐ is distance from the sole of the foot to the ankle, and D₁ is a typical “diameter” of the leg below the ankle. Equation (6) neglects the small effect of buoyancy on the submerged foot. We further suppose that in water of some depth Dₘₐₓ, it is unreasonable to consider an individual as standing even if water velocity is negligible. Representative values of Uₐ and Dₘₐₓ are shown in Table 1. One could in principle write an algebraic expression for critical water depth at any specified water speed, but this would simply create an unjustified aura of accuracy, and we instead propose as an alternative a simple criterion of the form

$${h}_{c} \approx 10 {D}_{a} ( 1 - \frac{{U}_{max}}{{U}_{ref}} ) \qquad ( 7 )$$

where the factor 10 is equal to our chosen Dₘₐₓ/Dₐ and to be cautious we choose U_{ref}=2.5 m/s, about 50% of the value of Uₐ (Table 1). We use Equation (7) along with the critical depths in Table 1 to define the three hazard layers for an inundation map. A figure is used to show that any person caught by the tsunami at campgrounds and boat ramps within the inundation zone is unlikely to remain standing, and may wind up being washed offshore.

TABLE 1
Quantities used to calculate the ability
to stand in the inundation zone

| | Type of Person | | |
|---|---|---|---|
| | Child | Woman | Man |
| m, typical mass (kg) | 15 | 55 | 80 |
| Dₐ, distance from ankle to sole of foot (m) | 0.04 | 0.08 | 0.08 |
| Dₗ, diameter of leg at the ankle (m) | 0.04 | 0.08 | 0.1 |
| Uₐ, critical velocity (m/s) | 3.5 | 4.5 | 5.0 |
| Dₘₐₓ, maximum standing depth (m) | 0.4 | 0.8 | 0.8 |

We also treat incipient vehicle motion based on a balance between hydrodynamic forces and frictional resistance. To determine the critical hydrodynamic force to displace a vehicle, we assume a characteristic mass for vehicle and occupants, and again take μ=0.3. Our treatment of car motion is conservative, because we assume that the car is being acted on from the side, rather than from the front, back, or some oblique angle. If the water height is below the bottom clearance of the car, then a drag force arises from the tires alone, and incipient motion can be found from an expression similar to Equation (4). Above the bottom clearance, water acts on the full length of the car. As we are more concerned with the safety of car occupants than with the details of car movement, it is sensible to suppose that for sufficiently deep water, a car can no longer be considered a safe haven, even if it is not actually displaced. We use the car types in Table 2 to define the three hazard layers. A figure is used to show that vehicles parked near campgrounds and boat ramps within the inundation zone cannot be considered safe havens.

TABLE 2
Quantities used to calculate the movement
of vehicles in the inundation zone

| | Vehicle size | | |
|---|---|---|---|
| | Small | Medium | Large |
| Bottom clearance (m) | 0.25 | 0.30 | 0.35 |
| Length (m) | 4 | 4.5 | 5 |
| Height (m) | 1.4 | 1.6 | 2.0 |
| Mass (kg) | 1000 | 2000 | 3000 |
| Force to displace (N) | 3000 | 6000 | 9000 |

Notation

The following symbols are used in the above discussion of Baker Lake:
b=typical dimension of large clast
C_{d}=hydrodynamic drag coefficient
d=sediment grain size
D=distance that boat is displaced by tsunami
Dₐ=distance from sole of person's foot to ankle
Dₜ=diameter of person's leg
Dₘₐₓ=maximum water depth in which a person can stand
f_{w}=volumetric water flux per unit width
F_{d}=drag force
Fₕ=anchor holding power
F_{w}=force per unit width exerted on structure by water wave
g=acceleration of gravity
h=water depth near end of wavemaker motion
h_{c} critical water depth for person to be able to stand
m=mass
tₐ=arrival time of first wave
t_{f}=time at which a place is last inundated
tᵢ=time of greatest hazard from water waves
tₘₐₓ=time of the maximum-elevation wave
tₘᵢₙ=time of the minimum-depression wave
tₛ=submerged travel time of wavemaker
u_{*}=friction velocity
Uₐ=water speed for which person will be swept off his feet in ankle-deep water
Uₘₐₓ=maximum water speed
vₛ=settling speed of sediment grain
V_{w}=wavemaker volume per unit width along shore
w=width of wavemaker along shore
x=horizontal coordinate measured from shore
γ=specific gravity of wavemaker
ρ=wave amplitude
ρ₀=characteristic value of wave amplitude
θ=dimensionless Shields' stress
θ_{c}=critical value of θ for initiation of bedload transport
λ₀=characteristic wavelength
μ=coefficient of friction
ρ_{w}=density of water
   Resulting Data

As alluded to in above Baker Lake example, a wide variety of data may be obtained from one or more tsunami simulation model runs. For example, for any given tsunami simulation model run, tsunami amplitudes, water velocities, water fluxes, wave breaking, geographic locations where people cannot stand, geographic locations where cars may be displaced, geographic locations where structures may be damaged, geographic locations where sand, gravel and boulders may be displaced, geographic locations were boat moorings may be broken, descriptions of free-floating boat's movements in the water, and the like can be obtained.

This analysis can be extended by combining probabilistic analysis, such as (1) stability analyses and (2) sediment motion (that can cause a tsunami) into a single hazards assessment model (HAM). The HAM is a probabilistic model that provides probability distributions for most hazards of interest. This is discussed further in U.S. Provisional Application No. 60/608,656, filed Sep. 10, 2004, which is incorporated herein by reference for all purposes.

Thus, for any given tsunami simulation model run, probabilistic outputs, such as mean, or median event magnitudes or likelihoods, standard deviations (or variations) of event outcomes, likelihood of events, skewness, confidence levels of events happening within a given time period (e.g., 100 years), all distributed spatially, can be obtained. For multiple tsunami simulation model runs, comparisons between tsunami simulation model results that can produce measures of confidence for tsunami simulation model parameters such as the tsunami simulation model interval and term can be obtained. These measures of confidence may be geographically dependent, and can be mapped to present geographic information on the confidence level of any given analysis. Sensitivity data regarding a wide array of parameters used in a tsunami simulation model run can also be obtained.

Presentation and Preservation of the Information—Mapping

The method of the embodiment preferably includes a step of preservation and presentation of the data, in any or all of a number of ways. The first such way is via mapping.

Preferably, for a given geologic hazard, i.e., a given geologic area and a given hazard type and level (e.g., a given type of tsunami source, or a tsunami of a given height), a presentation routine calculates a finite plurality of probability layers. Each probability layer contains data, e.g., data representing a probability range of a hazard level at locations over the geographic area (or a subset thereof) (i.e., data representing the region of locations over which a particular probability level of the hazard reaching the hazard level exists). Using this type of probability space presentation, a wide variety of data is preferably made available, including all of the above-mentioned physical and probabilistic quantities.

As an example, one probability layer could represent the geographic region over which a tsunami having a maximum water velocity of 10 m/s would occur with a probability of at least 2%, while a second probability layer could represent the geographic region over which a tsunami having a maximum water velocity of 10 m/s would occur with a probability of at least 25%. As a second example, one probability layer could represent the geographic region over which a tsunami of at least 20 feet would occur with a probability of at least 2%, while a second probability layer could represent the geographic region over which a tsunami of at least 20 feet would occur with a probability of at least 90%.

In some cases, assessments are preferably only run over relevant subsets of the total geographic area. Such an assessment area will typically be the area for which there is a significant possibility of a hazard level occurring. Also, it can sometimes be the case that the regions of one layer significantly overlap the regions of other layers. This might more likely to happen for areas having rapidly varying parameters, or for small hazard level variations. Nevertheless, even when this is the case, the small differences between regions might be particularly relevant.

While a first map can preferably be generated at a first hazard level, other maps can be generated at other hazard levels, providing a working group of maps that together indicate probability sensitivity by location over a geographic area. For example, a first map could pertain to the geographic region over which a tsunami has a maximum water velocity of 10 m/s, while a second map could pertain to the geographic region over which a tsunami has a maximum water velocity of 20 m/s.

Because complex layering can sometimes unnecessarily complicate a hazard analysis, the number of different probability ranges used in each map is preferably limited. Nevertheless, the number of probability ranges (and related layers) may be determined on a case by case basis by considering the relevant levels of effect, e.g., the important differences in danger (i.e., hazard) level or damage (i.e., risk) level.

A variety of other types of information layers may preferably be used with the probability layers. For example, additional layers preferably provide local geographic information, or even real-time data on the actual state of hazard parameters. For example, at various geographic locations, layers may be used to indicate a higher likelihood of locating oil, or the existence of unstable geologic conditions such as present volcanic activity. This information, in combination with tsunami probabilities could provide guidance as to locations with higher probabilities for finding oil and lower probabilities for having operations destroyed by a tsunami.

The preparation and production of the above-identified maps relating probability layers, the production of useful sets including relevant combinations (as noted above) of these layers, and the use of such sets of maps for hazard assessment (including exploration planning, hazard planning, hazard response, hazard mitigation and risk assessment), are within the anticipated scope of the invention.

Presentation and Preservation of the Information—GIS

Preferably, the data forming the various layers described above are compiled in respective layers of a geographical information system (“GIS”). As with the maps described above, the GIS provides an assessment tool for comparing relevant layer data and producing hazard assessment results. Using various hazard assessment results, exploration plans and emergency response plans may be prepared, and emergency crews can plan the timing and order of their efforts.

Therefore, the programming of layers representing the above-identified map layers relating to probability layers, the method of production of computer systems programmed with a GIS incorporating such layers, and the use of such a computer system for hazard assessment (including hazard planning, hazard response, hazard mitigation and risk assessment), is within the anticipated scope of the invention.

Routines

In developing the probability layers described above, various combinations of the above-noted routines are particularly useful. Additionally, routines for automatically importing and updating such layers into a GIS are particularly useful. The preparation and production of the above-identified routines for probability layers, the production of useful sets of such routines, and the use of such routines for the development of hazard assessment layers are within the anticipated scope of the invention. Furthermore, the routines themselves are within the scope of the invention, as available on a computer readable medium. Likewise, a computer configured to run such routines is within the scope of the invention, as are transmissions from a computer that incorporate the routines or the results of running the routines.

While particular forms of the invention have been illustrated and described, it will be apparent that various modifications can be made without departing from the spirit and scope of the invention. Thus, although the invention has been described in detail with reference only to the preferred embodiments, those having ordinary skill in the art will appreciate that various modifications can be made without departing from the scope of the invention. Accordingly, the invention is not intended to be limited by the above discussion, and is defined with reference to the following claim. Nevertheless, it is to be understood that the invention is further understood to be various combinations of the above-described features.

1. A method of tsunami hazard assessment, comprising:
establishing a tsunami scenario; and
compiling a plurality of geographic information layers regarding a particular tsunami hazard at a geographic location for a given target;
wherein each layer pertains to target bodies characterized by a different characteristic set of one or more target characteristics; and
wherein each layer provides data representing the geographic area over which the hazard will occur to any present target bodies characterized by the characteristic set to which the layer pertains.

2. A method of tsunami hazard assessment, comprising:
establishing a tsunami scenario; and
compiling a plurality of geographic information layers regarding particular tsunami characteristic magnitudes at a geographic location;
wherein each layer pertains to a range of tsunami characteristic magnitudes characterized by a different characteristic set of one or more tsunami characteristics.
